(19) United States
(12) Patent Application Publication
(10) Pub. No.: US 2024/0346394 A1
(43) Pub. Date: Oct. 17, 2024

(54) METHOD AND SYSTEM FOR PREDICTING CARBON EMISSION FROM AGRICULTURAL LAND

(71) Applicants: Nanjing Agricultural University, Nanjing (CN); Nanjing University, Nanjing (CN)

(72) Inventors: Penghui JIANG, Nanjing (CN); Yi HU, Nanjing (CN); Manchun LI, Nanjing (CN); Haiyue FU, Nanjing (CN)

(21) Appl. No.: 18/492,715

(22) Filed: Oct. 23, 2023

(30) Foreign Application Priority Data
Apr. 12, 2023 (CN) 202310386298.3

(51) Int. Cl. G06Q 10/04; G06Q 50/02

(52) U.S. Cl. CPC G06Q 10/04; G06Q 50/02

(57) ABSTRACT

The present invention provides a method and a system for predicting carbon emission from agricultural land, relates to the technical field of carbon emission prediction, comprising: Using the CLUMondo model to predict the agricultural land area of the target area at a future time; Determining methane emissions from paddy fields at a future time based on the area of rice planted in the agricultural land area; Determining the direct and indirect nitrous oxide emissions at a future time based on the nitrogen input to the agricultural land area; Determining methane emissions from animal enteric fermentation, methane emissions from animal manure management, and nitrous oxide emissions from animal manure management based on the number of animals in the agricultural land area.

### TECHNICAL FIELD

The present invention relates to the technical field of carbon emission prediction, in particular to a method and a system for predicting carbon emission from agricultural land.

### BACKGROUND ART

Global warming has a profound impact on human survival and development, and agriculture is one of the important sources of greenhouse gas emissions. It is generally believed that agricultural soil is the largest source of anthropogenic N₂O emissions, and paddy field are one of the main sources of greenhouse gases CH₄ and N₂O. In this context, agricultural carbon emissions have gradually become a research hotspot for scholars, and research has been carried out around agricultural carbon emission accounting, factors affecting agricultural carbon emissions, and agricultural carbon emission reduction mechanisms and policies. However, these studies or reports on agricultural carbon emissions rarely take into account the amount of greenhouse gas emissions from fertilizer application.

### SUMMARY OF THE INVENTION

In order to overcome the deficiencies of the prior art, the object of the present invention is to provide a method and a system for predicting carbon emission from agricultural land.

To achieve the above purpose, the present invention is implemented with the following technical scheme:
A prediction method for carbon emission from agricultural land, comprising:
Using the CLUMondo model to predict the agricultural land area of the target area at a future time;
Determining methane emissions from paddy fields at a future time based on the area of rice planted in the said agricultural land area;
Determining the direct and indirect nitrous oxide emissions at a future time based on the nitrogen input to the said agricultural land area;
Determining methane emissions from animal enteric fermentation, methane emissions from animal manure management, and nitrous oxide emissions from animal manure management based on the number of animals in the said agricultural land area.

Preferably, said determining methane emissions from paddy fields at a future time according to the rice planting area in the agricultural land area includes:

Using the formula:

$$\sum {E}_{{Future \_ CH}_{4}} = \sum {AD}_{Future \_ i} * {EF}_{Future \_ i}$$

Determine methane emissions from paddy fields at a future time; wherein, ΣE_{Future_CH}_{₄} represents the methane carbon emissions from the paddy fields in the future, AD_{Future_i} is the sowing area of various types of rice in the future, and EF_{Future_i} is the methane emission factor of early, middle and late rice in the future target year, and i represents the type of rice.

Preferably, the direct emission of nitrous oxide at a future time is determined according to the nitrogen input to the agricultural land area, including:

Using the formula:

$${N}_{2} {O}_{direct} = ( {N}_{fertilizer} + {N}_{manure} + {N}_{straw} ) * {EF}_{direct}$$

$${N}_{manure} = [ ( total nitrogen emissions from the livestock and poultry - grazing - used as fuel ) + total nitrogen emissions from the rural population ] * ( 1 - leaching and runoff loss rate 15 \% - volatilzation loss rate 20 \% )$$

$${N}_{straw} = ( \frac{Crop grain yield}{Economic coefficient} - Crop grain yield ) * Rate of straw return - to - field * Nitrogen content of straw + \frac{Crop grain yield}{Economic coefficient} * Root - shoot ratio * Nitrogen content of straw$$

Determine the direct nitrous oxide emissions at a future time; wherein, N₂O_{direct} represents the direct nitrous oxide emissions, N_{fertilizer} represents the direct nitrogen emissions from fertilizers, and EF_{direct} represents the factor of direct nitrous oxide emissions from agricultural land.

Preferably, the indirect emissions of nitrous oxide at a future time is determined according to the nitrogen input to the agricultural land area, including:

Using the formula:

$${N}_{2} {O}_{indirect} = {N}_{2} {O}_{deposition} + {N}_{2} {O}_{leaching}$$

$${N}_{2} {O}_{deposition} = ( {N}_{livestock and poultry} * 20 \% + {N}_{input} * 10 \% ) * 0.01$$

$${N}_{2} {O}_{leaching} = {N}_{inpuy} * 20 \% * 0.0075$$

Determine the indirect nitrous oxide emissions at a future time; wherein, N_{livestock and poultry} represents the volatilization of NH₃ and NOₓ from livestock and poultry manure, and Nᵢₙₚᵤₜ represents the volatilization of NH₃ and NOₓ from nitrogen input to the agricultural land.

Preferably, determining methane emissions from animal enteric fermentation based on the number of animals in said agricultural land area comprises:

Using the formula:

$${E}_{Fut \_ Ani {i \_ CH}_{4}} = {EF}_{Fut \_ Ani {i \_ CH}_{4}} * {AP}_{i} * {10}^{- 7}$$

Determine methane emissions from animal enteric fermentation; wherein, E_{Fut_Ani i_CH}_{₄} represents the future methane emission of the i^{th} animal, EF_{Fut_Ani i_CH}_{₄} represents the future factor of methane emissions from the i^{th} animal, and APᵢ is the number of the i^{th} animal.

Preferably, determining methane emissions from animal manure management based on the number of animals in said agricultural land area comprises:

Using the formula:

$${E}_{Animal 2 {i \_ CH}_{4}} = {EF}_{Animal 2 {i \_ CH}_{4}} * {AP}_{i} {10}^{- 7}$$

Determine methane emissions from animal manure management; wherein, E_{Animal2 i_CH}_{₄} represents the methane emissions from animal manure management for the i^{th} animal, EF_{Animal2 i_CH}_{₄} represents the factor of methane emissions from animal manure management for the i^{th} animal and APᵢ represents the number of the i^{th} animal.

Preferably, determining nitrous oxide emissions from animal manure management based on the number of animals in said agricultural land area comprises:

Using the formula:

$${E}_{Animal {i}_{-} {N}_{2} O} = {EF}_{Animal {i}_{-} {N}_{2} O} * A {P}_{i} * 1 {0}^{- 7}$$

wherein, E_{Animal i_N}_{₂}_{O} represents the nitrous oxide emissions from animal manure management for the i^{th} animal, EF_{Animal i_N}_{₂}_{O} represents the factor of nitrous oxide emissions from animal manure management for the i^{th} animal and APᵢ represents the number of the i^{th} animal.

The present invention further provides a system for carbon emission prediction from agricultural land, comprising:
An agricultural land area prediction module for predicting the agricultural land area of a target area at a future time using the CLUMondo model;
A paddy field methane emission prediction module for determining the paddy field methane emissions at a future time according to the planting area of rice in the agricultural land area;
A nitrous oxide emission prediction module for determining the direct and indirect nitrous oxide emissions at a future time according to the nitrogen input to the agricultural land area;
An animal carbon emission prediction module, which is used to determine methane emissions from animal enteric fermentation, methane emissions from animal manure management, and nitrous oxide emissions from animal manure management based on the number of animals in the said agricultural land area.

According to specific embodiments, the present invention discloses the following technical effects:

The present invention provides a method and a system for predicting carbon emission from agricultural land comprising: Using the CLUMondo model to predict the agricultural land area of the target area at a future time; Determining methane emissions from paddy fields at a future time based on the area of rice planted in the agricultural land area; Determining the direct and indirect nitrous oxide emissions at a future time based on the nitrogen input to the agricultural land area; Determining methane emissions from animal enteric fermentation, methane emissions from animal manure management, and nitrous oxide emissions from animal manure management based on the number of animals in the agricultural land area. The present invention uses the CLUMondo model to predict the agricultural land area of a target area at a future time, and calculates the carbon emissions in various scenarios based on the predicted agricultural land area, which can greatly improve the carbon emission prediction accuracy of the target area at a future time.

### DESCRIPTION OF DRAWINGS

To better describe the technical scheme of the embodiment of the present invention or the prior art, a brief introduction to the accompanying drawings to be used in the descriptions of the embodiment or the prior art is given below. Obviously, the drawings below are only the embodiment of the present invention, and for those ordinarily skilled in the art, other drawings based on such drawings can be obtained without making creative endeavors.

FIG. 1 is a flow chart of a method for predicting carbon emissions from agricultural land provided by the present invention;

FIG. 2 is the regional distribution statistical diagram of agricultural carbon emissions in 1990-2020 provided by the present invention;

FIG. 3 is the carbon source structure statistical diagram of agricultural carbon emissions in 1990-2020 provided by the present invention;

FIG. 4 is the gas type statistical diagram of agricultural carbon emissions in 1990-2020 provided by the present invention.

### DETAILED DESCRIPTION OF EMBODIMENTS

The technical schemes in the embodiments of the present invention will be clearly and completely described below in combination with the drawing in the embodiments of the present invention. Obviously, such embodiments are just a part of embodiments of the present invention, not all of them. Based on the embodiments of the present invention, all the other embodiments obtained by those ordinarily skilled in the art without making creative endeavors shall fall into the scope of protection of the present invention.

Reference herein to an “embodiment” means that a particular feature, structure, or characteristic described in connection with the embodiment can be included in at least one embodiment of the present application. The occurrences of this phrase in various places in the specification are not necessarily all referring to the same embodiment, nor are separate or alternative embodiments mutually exclusive of other embodiments. It is understood explicitly and implicitly by those skilled in the art that the embodiments described herein can be combined with other embodiments.

The terms “first”, “second”, “third”, “fourth”, etc. in the specification and claims and the drawings of the present application are used to distinguish different objects, rather than to describe a specific order. Furthermore, the terms “include” and “have”, as well as any variations thereof, are intended to cover a non-exclusive inclusion. For example, a series of steps, processes, methods, etc. are not limited to the listed steps, but optionally also include steps that are not listed, or optionally also include other steps inherent to these processes, methods, products or equipment.

In order to make the above purpose, characteristics and advantages of the present invention more understandable, the invention will be described further with the following attached figures and embodiments.

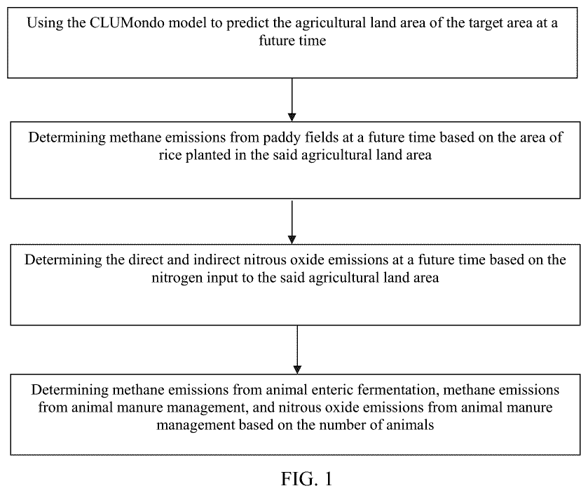

Please refer to FIG. 1, a method for predicting carbon emissions from agricultural land, comprising:
Step 1: Using the CLUMondo model to predict the agricultural land area of the target area at a future time;

It should be noted that the present invention needs to prepare relevant historical data before using the CLUMondo model to predict the agricultural land area of a target area at a future time. Further, the land use/cover data, terrain data, socioeconomic data, and nature reserve boundary data used in the present invention come from the Resource and Environment Science and Data Center, the Chinese Academy of Sciences. The land use/cover data are selected from the remotely sensed data sets of land use in China, including 6 first-level types and 25 second-level types of cultivated land, forest land, grassland, water area, residential area and unused land; the topographic data are selected from DEM elevation data, the slope data can be obtained by slope analysis of the DEM data in ArcGIS; the socioeconomic data are selected from the kilometer grid data of China's population spatial distribution and the kilometer grid data of China's GDP spatial distribution; the nature reserve boundary data are selected from the boundary data of China's nature reserves in 2018. The meteorological data come from the National Tibetan Plateau Data Center, and the average temperature and precipitation in 2000 and 2020 are selected. The soil data come from the Harmonized World Soil Database, and seven factors including sediment content, silt content, clay content, drainage level, soil available water content, pH, and organic carbon content are selected to represent soil property characteristics. In addition, the river data come from the National Catalogue Service For Geographic Information, and the data on rural population, crop production, livestock numbers, and fertilizer use from 1990 to 2020 come from the China Agricultural Yearbook and the China Rural Statistical Yearbook. The above vector or raster data are all resampled to 1 km×1 km in the unified coordinate system.

The agricultural greenhouse gas inventory includes four parts: the first is methane emissions from paddy fields, the second is nitrous oxide emissions from agricultural land, the third is methane emissions from animal enteric fermentation, and the fourth is methane and nitrous oxide emissions from animal manure management. The calculation and prediction of each process are as follows:
Step 2: Determining methane emissions from paddy fields at a future time based on the area of rice planted in the said agricultural land area;

The present invention first needs to determine the emission factor and activity level of the paddy field type, and then calculates the methane emissions according to the following formula:

$$\sum {E}_{{CH}_{4}} = \sum {AD}_{i} * {EF}_{i} \qquad ( 1 )$$

wherein, ΣE_{CH}_{₄} represents the methane carbon emissions of paddy fields, ADᵢ is the planting area of various types of rice, and EFᵢ is the methane emission factor of early, middle and late rice, and i represents the rice type; the value ranges of the emission factors for various types of rice are as follows: middle rice: 134.4-341.9 in North China; 134.4-341.9 in South China; 170.2-320.1 in Central and South China; 75.0-246.5 in Southwest China; 112.6-230.3 in Northeast China; 175.9-319.5 in Northwest China. Early rice: 153.1-259.0 in East China; 169.5-387.2 in Central and South China; 73.7-276.6 in Southwest China. Late rice: 143.4-261.3 in East China; 185.3-357.9 in Central and South China; 75.1-265.1 in Southwest China.
2. Calculation of methane emissions from paddy fields in the future. In view of the fact that China's grain production structure is basically in a stable state, it is assumed that the proportion of early, middle and late rice planting in China will maintain the status quo in the future. The CLUMondo model is used to predict the future rice area in China. The simulation of land use change in the future target year does not consider the influence of other factors, and develops according to the existing trend. The calculation formula is as follows:

$$\sum {E}_{{Future}_{-} {CH}_{4}} = \sum {AD}_{{Future}_{-} i} * {EF}_{{Future}_{-} i} \qquad ( 2 )$$

wherein, ΣE_{Future_CH}_{₄} represents the methane carbon emissions from the paddy fields in the future, AD_{Future_i} is the sowing area of various types of rice in the future, and EF_{Future_i} is the methane emission factor of early, middle and late rice in the future target year, assuming that the factor is the same with that in the base year, and i represents the type of rice.
Step 3: Determining the direct and indirect nitrous oxide emissions at a future time based on the nitrogen input to the said agricultural land area;

Nitrous oxide emissions from agricultural land include two parts: direct emissions and indirect emissions. Direct emissions are those resulted from seasonal nitrogen inputs to agricultural land. The nitrogen input includes nitrogen fertilizer, manure and straw return-to-field. Indirect emissions include nitrous oxide emissions from atmospheric nitrogen deposition and nitrous oxide emissions from nitrogen leaching runoff losses.

### 1. DIRECT NITROUS OXIDE EMISSIONS FROM AGRICULTURAL LAND

Nitrogen input to agricultural land mainly includes fertilizer nitrogen (nitrogen in nitrogen fertilizers and compound fertilizers), nitrogen in manure, nitrogen in straw return-to-field (including aboveground straw returning nitrogen and underground root nitrogen), and the calculation formula for direct nitrous oxide emission N₂O_{direct} from agricultural land is as follows:

$${N}_{2} {O}_{direct} = ( {N}_{fertilizer} + {N}_{manure} + {N}_{straw} ) * {EF}_{direct} wherein , \qquad ( 3 )$$

$${N}_{manure} = \text{} [ \text{} ( total nitrogen emissions from the livestock and poultry - grazing - used as fuel ) + total nitrogen emissions from the rual population ] * ( 1 - leaching and runoff loss rate 15 \% - volatilization loss 20 \% ) \qquad ( 4 )$$

$${N}_{straw} = ( \frac{Crop grain yield}{Economic coefficient} - Crop grain yield ) * Rate of straw return - to - field * Nitrogen content of straw + \frac{Crop grain yield}{Economic coefficient} * Root - shoot ratio * Nitrogen content of straw \qquad ( 5 )$$

### 2. INDIRECT NITROUS OXIDE EMISSIONS FROM AGRICULTURAL LAND

The indirect nitrous oxide emissions from agricultural land (N₂O_{indirect}) include nitrous oxide emission from nitrogen oxides and ammonia volatilization in fertilized soil and livestock and poultry manure through atmospheric nitrogen deposition (N₂O_{deposition}), and nitrous oxide emissions caused by soil nitrogen leaching or runoff loss (N₂O_{leaching}) into water bodies. The calculation formulas for both are as follows:

$${N}_{2} {O}_{deposition} = ( {N}_{livestock and poultry} * 20 \% + {N}_{input} * 10 \% ) * 0 \text{.01} \qquad ( 6 )$$

$${N}_{2} {O}_{leaching} = {N}_{input} * 20 \% * 0.0075 \qquad ( 7 )$$

In the calculation of nitrous oxide emissions from agricultural land, the nitrogen in compound fertilizers is calculated according to 15% nitrogen of general-purpose compound fertilizers; the nitrogen emission from rural population is taken as 5.6 kg/person/year; the available amount of livestock and poultry manure is taken as 30%; before 2000, the rate of straw return-to-field is set at 15%. In 2010, the rate of straw return-to-field of 38% in 2011 was selected, and in 2020 it was 51.2%. The nitrogen emission of different animals is as follows: non-dairy cows 40 kg/head/year; dairy cows 60 kg/head/year; poultry 0.6 kg/head/year; sheep 12 kg/head/year; pigs 16 kg/head/year; other animals 40 kg/head/year. The direct emission factors of nitrous oxide from agricultural land in different regions are as follows: Inner Mongolia, Xinjiang, Gansu, Qinghai, Tibet, Shaanxi, Shanxi, and Ningxia range from 0.0015 to 0.0085; Heilongjiang, Jilin, and Liaoning range from 0.0021 to 0.0258; Beijing, Tianjin, Hebei, Henan, and Shandong range from 0.0014 to 0.0081; Zhejiang, Shanghai, Jiangsu, Anhui, Jiangxi, Hunan, Hubei, Sichuan, and Chongqing range from 0.0026 to 0.022; Guangdong, Guangxi, Hainan, and Fujian range from 0.0046 to 0.0228; Yunnan and Guizhou range from 0.0025 to 0.0218. The main crop parameters are as follows:

TABLE 1
Main crop parameters

| Crop | Wet to dry | Nitrogen | Nitrogen | | Root- |
|---|---|---|---|---|---|
| parameter | weight | content of | content of | Economic | shoot |
| table | ratio | grain | straw | coefficient | ratio |
| Rice | 0.855 | 0.01 | 0.00753 | 0.489 | 0.125 |
| Wheat | 0.87 | 0.014 | 0.00516 | 0.434 | 0.166 |
| Corn | 0.86 | 0.017 | 0.0058 | 0.438 | 0.17 |
| Sorghum | 0.87 | 0.017 | 0.0073 | 0.393 | 0.185 |
| Millet | 0.83 | 0.007 | 0.0085 | 0.385 | 0.166 |
| Other cereals | 0.83 | 0.014 | 0.0056 | 0.455 | 0.166 |
| Soybean | 0.86 | 0.06 | 0.0181 | 0.425 | 0.13 |
| Other beans | 0.82 | 0.05 | 0.022 | 0.385 | 0.13 |
| Rapeseed | 0.82 | 0.00548 | 0.00548 | 0.271 | 0.15 |
| Peanut | 0.9 | 0.05 | 0.0182 | 0.556 | 0.2 |
| Sesame | 0.9 | 0.05 | 0.0131 | 0.417 | 0.2 |
| Seed cotton | 0.83 | 0.00548 | 0.00548 | 0.383 | 0.2 |
| Beet | 0.4 | 0.004 | 0.00507 | 0.667 | 0.05 |
| Sugarcane | 0.32 | 0.004 | 0.83 | 0.75 | 0.26 |
| Hemp | 0.83 | 0.0131 | 0.0131 | 0.83 | 0.2 |
| Potatoes | 0.45 | 0.004 | 0.011 | 0.667 | 0.05 |
| Vegetables | 0.15 | 0.008 | 0.008 | 0.83 | 0.25 |
| Tobacco leaf | 0.83 | 0.041 | 0.0144 | 0.83 | 0.2 |

### 3. DIRECT/INDIRECT NITROUS OXIDE EMISSIONS FROM AGRICULTURAL LAND IN THE FUTURE

In the calculation of direct/indirect nitrous oxide emissions from agricultural land in the future, the linear regression method is selected for the amount of fertilizer application, the number of livestock, crop production and rural population. The annual change rate is used to estimate the above factors for provinces that fail the test of significance. The rate of straw return-to-field is consistent with the base year, and formulas 3-7 are selected for calculation.

Step 4: Determining methane emissions from animal enteric fermentation, methane emissions from animal manure management, and nitrous oxide emissions from animal manure management based on the number of animals in the said agricultural land area.

I. According to the livestock breeding situation and data availability in each province, sources of methane emissions from animal enteric fermentation include non-dairy cows, buffaloes, dairy cows, goats, sheep, pigs, horses, donkeys, mules, camels, etc. The methane emission from enteric fermentation of an animal is calculated by formula 8:

$${E}_{Animal 1 {i}_{-} {CH}_{4}} = {EF}_{Animal 1 {i}_{-} {CH}_{4}} * {AP}_{i} * 1 {0}^{- 7} \qquad ( 8 )$$

wherein, E_{Animal1 i_CH}_{₄} represents the methane emission of the i^{th} animal, E_{Animal1 i_CH}_{₄} represents the factor of methane emissions from the i^{th} animal, and APᵢ is the number of the i^{th} animal. Wherein, the methane emission factor from animal enteric fermentation is as shown in the table below, in kg/head/year.

TABLE 2
Methane emission factor from animal enteric fermentation

| Feeding | Dairy | Non-dairy | | | | | | Donkeys/ | |
|---|---|---|---|---|---|---|---|---|---|
| methods | cows | cows | Buffaloes | Goats | Sheep | Pigs | Horses | mules | Camels |
| Large-scale | 88.1 | 52.9 | 70.5 | 8.9 | 8.2 | 1 | 18 | 10 | 46 |
| breeding | | | | | | | | | |
| Free-ranging | 89.3 | 67.9 | 87.7 | 9.4 | 8.7 | | | | |
| by farmers | | | | | | | | | |
| Free-range | 99.3 | 85.3 | — | 6.7 | 7.5 | | | | |
| raising | | | | | | | | | |

II. Methane emissions from animal enteric fermentation in the future. The number of livestock in the future target year adopts the linear regression method, and the annual change rate to estimate the number of livestock in the future target year for provinces that fail the test of significance. The methane emission from enteric fermentation of an animal in the future target year is calculated by formula 9:

$${E}_{Fut\_Ani {i \_ CH}_{4}} = {EF}_{Fut\_Ani {i\_CH}_{4}} * {AP}_{i} * 1 {0}^{- 7} \qquad ( 9 )$$

wherein, E_{Fut_Ani i_CH}_{₄} represents the future methane emission of the i^{th} animal, EF_{Fut_Ani i_CH}_{₄} represents the future factor of methane emissions from the i^{th} animal, and APᵢ is the number of the i^{th} animal. Wherein, the methane emission factor from animal enteric fermentation remains unchanged.

III. According to the livestock and poultry breeding situation and data availability in each province, sources of methane emissions from animal manure management include pigs, non-dairy cows, buffaloes, dairy cows, goats, sheep, poultry, horses, donkeys, mules, and camels. The methane emission from animal manure management of an animal is calculated by formula 10:

$${E}_{Animal 2 {i\_CH}_{4}} = {EF}_{Animal 2 {i\_CH}_{4}} * {AP}_{i} * {10}^{- 7} \qquad ( 10 )$$

wherein, E_{Animal2 i_CH}_{₄} represents the methane emissions from animal manure management for the i^{th} animal, EF_{Animal2 i_CH}_{₄} represents the factor of methane emissions from animal manure management for the i^{th} animal and APᵢ represents the number of the i^{th} animal. Wherein, the methane emission factor from animal manure management is as shown in the table below, in kg/head/year.

TABLE 3
Methane emission factor from manure management

| | | Non- | | | | | | | | |
|---|---|---|---|---|---|---|---|---|---|---|
| | Dairy | dairy | | | | | | | Donkeys/ | |
| Region | cows | cows | Buffaloes | Sheep | Goats | Pigs | Poultry | Horses | mules | Camels |
| North | 7.46 | 2.82 | — | 0.15 | 0.17 | 3.12 | 0.01 | 1.09 | 0.60 | 1.28 |
| China | | | | | | | | | | |
| Northeast | 2.23 | 1.02 | — | 0.15 | 0.16 | 1.12 | 0.01 | 1.09 | 0.60 | 1.28 |
| China | | | | | | | | | | |
| East | 8.33 | 3.31 | 5.55 | 0.26 | 0.28 | 5.08 | 0.02 | 1.64 | 0.90 | 1.92 |
| China | | | | | | | | | | |
| South | 8.45 | 4.72 | 8.24 | 0.34 | 0.31 | 5.85 | 0.02 | 1.64 | 0.90 | 1.92 |
| Central | | | | | | | | | | |
| China | | | | | | | | | | |
| Southwest | 6.51 | 3.21 | 1.53 | 0.48 | 0.53 | 4.18 | 0.02 | 1.64 | 0.90 | 1.92 |
| China | | | | | | | | | | |
| Northwest | 5.93 | 1.86 | — | 0.28 | 0.32 | 1.38 | 0.01 | 1.09 | 0.60 | 1.28 |
| China | | | | | | | | | | |

IV. Nitrous oxide emission from animal manure management

Pigs, non-dairy cows, buffaloes, dairy cows, goats, sheep, poultry, horses, donkeys, mules, and camels are identified as sources of nitrous oxide emissions from animal waste management according to the livestock and poultry breeding conditions in each province.

$${E}_{Animal {i\_N}_{2} O} = {EF}_{Animal {i\_N}_{2} O} * {AP}_{i} * 1 {0}^{- 7} \qquad ( 11 )$$

wherein, E_{Animal i_N}_{₂}_{O} represents the nitrous oxide emissions from animal manure management for the i^{th} animal, EF_{Animal i_N}_{₂}_{O} represents the factor of nitrous oxide emissions from animal manure management for the i^{th} animal and APᵢ represents the number of the i^{th} animal. Wherein, the nitrous oxide emission factor from animal manure management is as shown in the table below, in kg/head/year.

TABLE 4
Nitrous oxide emission factor from manure management

| | | Non- | | | | | | | | |
|---|---|---|---|---|---|---|---|---|---|---|
| | Dairy | dairy | | | | | | | Donkeys/ | |
| Region | cows | cows | Buffaloes | Sheep | Goats | Pigs | Poultry | Horses | mules | Camels |
| North | 1.846 | 0.794 | — | 0.093 | 0.093 | 0.227 | 0.007 | 0.330 | 0.188 | 0.330 |
| China | | | | | | | | | | |
| Northeast | 1.096 | 0.913 | — | 0.057 | 0.057 | 0.266 | | | | |
| China | | | | | | | | | | |
| East | 2.065 | 0.846 | 0.875 | 0.113 | 0.113 | 0.175 | | | | |
| China | | | | | | | | | | |
| South | 1.710 | 0.805 | 0.860 | 0.106 | 0.106 | 0.157 | | | | |
| Central | | | | | | | | | | |
| China | | | | | | | | | | |
| Southwest | 1.884 | 0.691 | 1.197 | 0.064 | 0.064 | 0.159 | | | | |
| China | | | | | | | | | | |
| Northwest | 1.447 | 0.545 | — | 0.074 | 0.074 | 0.195 | | | | |
| China | | | | | | | | | | |

V Methane and nitrous oxide emissions from animal manure management in the future

In the calculation of methane and nitrous oxide emissions from animal manure management in the future, the linear regression method is selected for the number of livestock, and the provinces that fail the test of significance are estimated by the annual change rate, and then formulas 10-11 are selected for calculation.

TABLE 5
Required data sources and factor selection

| Data sets | Factors and determinants | Timing | Resolution |
|---|---|---|---|
| Land use/cover data | — | 1990, 2000, | 1 km, — |
| | | 2010, 2020 | |
| Climate | Temperature | 2000, 2020 | 1 km, 0.1° C. |
| | Precipitation | 2000, 2020 | 1 km, 0.1 mm |
| Terrain | Elevation | — | 1 km, m |
| | Slope | — | 1 km, ° |
| Soil | Sediment content | 2009 | 1 km, % |
| | Silt content | 2009 | 1 km, % |
| | Clay content | 2009 | 1 km, % |
| | Drainage level | 2009 | 1 km, Class |
| | Soil available water content | 2009 | 1 km, Class |
| | pH | 2009 | 1 km, −log(H+) |
| | Organic carbon content | 2009 | 1 km, % |
| Socio-economic | Population density | 2000, 2019 | 1 km, persons/km² |
| | Economic density | 2000, 2019 | 1 km, 10⁴ yuan/km² |
| | Rural population | 1990-2021 | —, 10⁴ persons |
| | Grain yield | 1990-2021 | —, 10⁴ t |
| | Number of livestock | 1990-2019 | —, 10⁴ h |
| | Amount of fertilizer application | 1990-2020 | —, 10⁴ t |
| Other | River network | 2015 | 1:1000000 |
| | Nature reserve | 2018 | — |

In order to verify the applicability of the CLUMondo model in the present invention, its simulation results need to be verified. Due to incomplete data in 1990, the land use simulation in 2015 was completed based on the above settings based on 2000, when the data was more complete. The study used the MCK map comparison tool to verify the accuracy of the simulation results in 2015, and counted the standard Kappa index, location Kappa index, and numerical Kappa index of the seven regions in China (Table 6). After testing, the standard Kappa value of the simulation results in 2015 is 0.746, and the overall accuracy is 80.3700, among which the user accuracy of cultivated land and paddy fields is 93.85% and 70.83%. In terms of regions, the simulation accuracy in South China, Central China, and Northeast China is relatively high, with standard Kappa indexes of 0.822, 0.821, and 0.804, respectively, while the simulation accuracy in Northwest China is relatively low, with a standard Kappa index of 0.611. In general, the simulation results of the model are relatively reliable and meet the accuracy requirements required by the research.

TABLE 6
Accuracy verification of simulation results in 2015

| | | | | | | North | |
|---|---|---|---|---|---|---|---|
| | Northeast | East | Central | North | South | west | Southwest |
| Kappa index | China | China | China | China | China | China | China |
| Standard Kappa | 0.804 | 0.773 | 0.821 | 0.705 | 0.822 | 0.611 | 0.705 |
| index | | | | | | | |
| Location Kappa | 0.925 | 0.857 | 0.870 | 0.751 | 0.902 | 0.681 | 0.790 |
| index | | | | | | | |
| Numerical | 0.869 | 0.902 | 0.943 | 0.939 | 0.911 | 0.897 | 0.892 |
| Kappa index | | | | | | | |

### 2.3.2 Changes in Land Use

Different socio-economic development and environmental protection levels have different impacts on land use. The land use change simulated by the present invention in 2035 does not consider the influence of other factors, and develops according to the existing trend, and the conversion rules are set according to the model parameters of each region in 2000-2015. For land use demand, refer to the Statistical Yearbook and related industrial development planning, in accordance with the requirements on rice production, livestock quantity and construction land demand in each region from 1990 to 2020, the annual change rate is used to predict the requirements on the total rice production, livestock quantity and construction land area in the next 15 years.

### 3. RESULTS

### 3.1 Basic Status of Agricultural Carbon Emissions

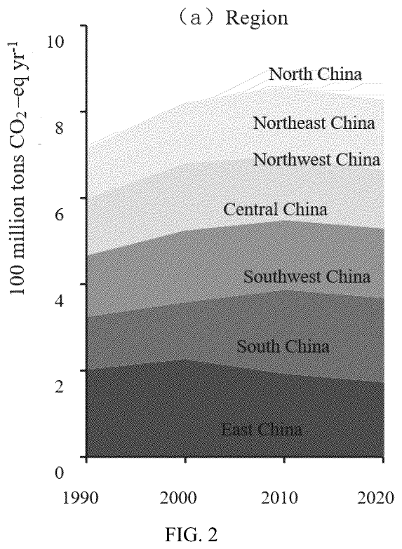

The study counts the carbon emissions in China's agricultural sector from three aspects: regional distribution, carbon source structure, and gas type (FIG. 2-4). Overall, agricultural carbon emissions increased first and then decreased between 1990 and 2020, showing that agricultural carbon emissions increased rapidly between 1990 and 2010, from 767 million tons to 937 million tons, among which, the emissions increased more from 1990 to 2000 with an average annual increase of 13 million tons, and from 2000 to 2010, the growth rate slowed down, with an average annual increase of 4 million tons; from 2010 to 2020, agricultural carbon emissions decreased to 896 million tons, with an average annual decrease of 4 million tons (Table 7).

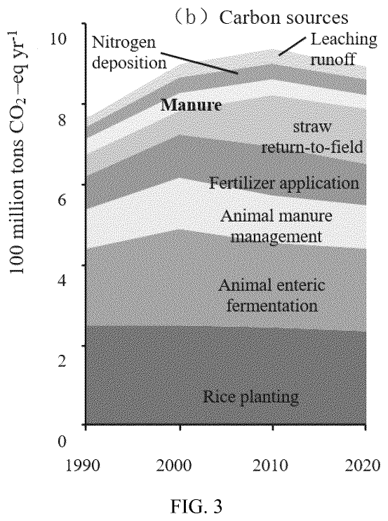

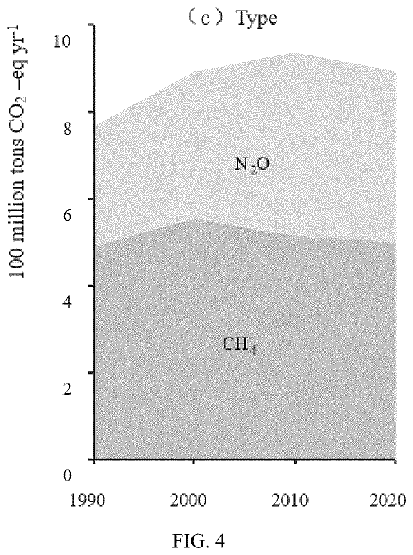

In terms of regional distribution, East China, South China, Southwest China, and Central China are the main areas of agricultural carbon emissions, and the proportions of the four regions range from 74% to 77.49%. During this period, agricultural carbon emissions in East China showed a downward trend. From 1990 to 2020, agricultural carbon emissions fell from 201 million tons to 170 million tons, a drop of 31 million tons, a drop of 15.43%, and the proportion of the region to the county also dropped from 26.25% to 19.02%. Combined with FIG. 2, it can be seen that the decline in agricultural carbon emissions in East China is mainly caused by the reduction of methane emissions from rice planting and animal enteric fermentation; the agricultural carbon emissions in the other six regions have increased to varying degrees, and the largest increases are in South China and Northeast China, with an increase of 75 million tons and 29 million tons, respectively and the increase has reached 61.62% and 59.93% respectively. The reason for this is that the increase in agricultural carbon emissions from South China is caused by the increase in nitrous oxide emissions during the straw return-to-field process, while in Northeast China it is mainly caused by the increase in methane emissions from rice planting and animal enteric fermentation (FIG. 2, Table 7). In terms of carbon source structure, different carbon sources have different change characteristics: carbon emissions from rice planting remain basically unchanged, carbon emissions from animal enteric fermentation, animal manure management, and fertilizer application increase first and then decrease, and carbon emissions from straw return-to-field continue to increase. Among them, rice planting and animal enteric fermentation have always been the largest sources of agricultural carbon emissions in China, but the proportion of the two decreased from 57.38% to 49.12%, showing a downward trend; from 1990 to 2000, carbon emissions from animal enteric fermentation and animal manure management increased significantly, with an increase of 51 million tons and 26 million tons respectively, and then gradually decreased; from 1990 to 2010, carbon emissions from fertilizer application increased by 40 million tons; carbon emissions from straw return-to-field had the largest change, from 54 million tons to 139 million tons, an increase of 85 million tons, an increase reaching 156.92%, because the increase in the use of crop straw return-to-field has promoted nitrous oxide emissions of soil (FIG. 3, Table 7). From the perspective of greenhouse gas types, the proportion of methane presents a dynamic downward trend, from 63.84% in 1990 to 55.48% in 2020; the proportion of nitrous oxide gradually increases, and its proportion increases to 44.52% (FIG. 4, Table 7).

TABLE 7
Statistics of agricultural carbon emissions from 1990 to 2020

| | | 1990 | | 2000 | | 2010 | | 2020 | |
|---|---|---|---|---|---|---|---|---|---|
| | | 100 | Propor- | 100 | Propor- | 100 | Propor- | 100 | Propor- |
| Agricultural carbon | | million | tion | million | tion | million | tion | million | tion |
| emission | | tons | (%) | tons | (%) | tons | (%) | tons | (%) |
| Region | North China | 0.53 | 6.92 | 0.75 | 8.31 | 0.78 | 8.27 | 0.69 | 7.73 |
| | Northeast | 0.49 | 6.4 | 0.68 | 7.54 | 0.82 | 8.76 | 0.79 | 8.77 |
| | China | | | | | | | | |
| | East China | 2.01 | 26.25 | 2.24 | 25.01 | 1.93 | 20.63 | 1.70 | 19.02 |
| | Central China | 1.28 | 16.7 | 1.58 | 17.58 | 1.54 | 16.48 | 1.36 | 15.24 |
| | South China | 1.23 | 15.96 | 1.35 | 15.04 | 1.91 | 20.41 | 1.98 | 22.1 |
| | Southwest | 1.43 | 18.58 | 1.63 | 18.19 | 1.62 | 17.27 | 1.58 | 17.64 |
| | China | | | | | | | | |
| | Northwest | 0.71 | 9.19 | 0.75 | 8.34 | 0.77 | 8.18 | 0.85 | 9.5 |
| | China | | | | | | | | |
| Total | | 7.67 | 100 | 8.97 | 100 | 9.37 | 100 | 8.96 | 100 |
| Carbon | Rice planting | 2.48 | 32.35 | 2.48 | 27.59 | 2.42 | 25.8 | 2.35 | 26.23 |
| sources | Fertilizer | 0.82 | 10.67 | 1.08 | 12.03 | 1.22 | 13 | 1.01 | 11.23 |
| | application | | | | | | | | |
| | Manure | 0.39 | 5.07 | 0.44 | 4.95 | 0.38 | 4.08 | 0.33 | 3.73 |
| | straw | 0.54 | 7.05 | 0.62 | 6.92 | 1.25 | 13.31 | 1.39 | 15.53 |
| | return-to-field | | | | | | | | |
| | Nitrogen | 0.32 | 4.18 | 0.39 | 4.35 | 0.42 | 4.46 | 0.38 | 4.29 |
| | deposition | | | | | | | | |
| | Leaching | 0.24 | 3.11 | 0.30 | 3.38 | 0.38 | 4.01 | 0.35 | 3.93 |
| | runoff | | | | | | | | |
| | Animal | 1.92 | 25.03 | 2.43 | 27.13 | 2.12 | 22.65 | 2.05 | 22.89 |
| | enteric | | | | | | | | |
| | fermentation | | | | | | | | |
| | Animal | 0.96 | 12.53 | 1.22 | 13.65 | 1.19 | 12.69 | 1.09 | 12.17 |
| | manure | | | | | | | | |
| | management | | | | | | | | |
| Total | | 7.67 | 100 | 8.97 | 100 | 9.37 | 100 | 8.96 | 100 |
| Type | CH₄ | 4.90 | 63.84 | 5.53 | 61.64 | 5.16 | 55.05 | 4.97 | 55.48 |
| | N₂O | 2.78 | 36.16 | 3.44 | 38.36 | 4.21 | 44.95 | 3.99 | 44.52 |

| | | | | | | | | |
|---|---|---|---|---|---|---|---|---|
| Total | 7.67 | 100 | 8.97 | 100 | 9.37 | 100 | 8.96 | 100 |

In order to better discover inter-provincial differences in agricultural carbon emissions, the study separately counts the agricultural carbon emissions of each province in China. From 1990 to 2020, China's inter-provincial agricultural carbon emissions showed a spatial distribution pattern of “high in the south and low in the north”. In 1990, the provinces with high agricultural carbon emissions were mainly concentrated in the Sichuan Basin, the middle and lower reaches of the Yangtze River, and the Pearl River Basin, including Sichuan, Guangdong, Guangxi, Hunan, Jiangsu, Anhui, Hubei and other major agricultural provinces; in 2000, the provinces with large agricultural carbon emissions have increased on the basis of 1990, expanding to Henan and Shandong in the North China Plain in the north, and spreading to Yunnan in the Yunnan-Guizhou Plateau in the south. At the same time, agricultural carbon emissions in provinces, such as Heilongjiang and Jilin in the Northeast and Xinjiang in the Northwest have increased significantly; the spatial distribution pattern of agricultural carbon emissions has remained basically unchanged from 2000 to 2010; 2020 has seen decreases in provinces with large agricultural carbon emissions, and the provinces with large emissions are mainly located in the south-central provinces of Guangxi, Sichuan, Guangdong, Hunan, Yunnan, Hubei, and northeast Heilongjiang.

In terms of carbon source structure, there are also large differences among provinces. The southeastern provinces mainly produce carbon emissions from rice planting, while the northwest region mainly produces carbon emissions from animal enteric fermentation. Specifically, in Shanghai, Jiangsu, Zhejiang, Anhui, Jiangxi, Hubei, Hunan and other provinces in the plains of the middle and lower reaches of the Yangtze River, and the Ningxia Hui Autonomous Region in the northwest inland, the agricultural carbon source in the above areas is mainly rice planting. Its carbon emissions account for more than 50% of the agricultural carbon emissions of the province. Agricultural carbon emissions in Inner Mongolia, Xinjiang, Qinghai, Tibet, Gansu and other pastoral areas are mainly from animal enteric fermentation. Considering carbon emissions from animal manure management in pastoral areas, the sum of the above-mentioned two emissions all accounts for more than 80% of the agricultural carbon emissions of the province; In addition, other provinces in the south, as well as the Northeast, are traditional agricultural areas with vast rice planting areas. The amount of fertilizer application is large, and the scale of livestock and poultry breeding is large, so rice planting, chemical fertilizer application and animal enteric fermentation constitute the main body of agricultural carbon emissions; Guangdong, Guangxi, Yunnan, Hainan and other provinces are concentrated sugarcane production areas in China. Due to the high nitrogen content of sugarcane straw, changes in the rate of straw return-to-field lead to large fluctuations in agricultural carbon emissions; Hebei, Shanxi, Liaoning, Shaanxi and other provinces are China's agricultural and animal husbandry ecotones, and the carbon sources of Hebei and Shanxi are mainly fertilizer application, animal enteric fermentation and animal manure management, while Liaoning and Shaanxi mainly focus on rice planting and animal enteric fermentation.

Based on the land use data in 2020 and the model parameters provided above, the simulation map of China's agricultural land in 2035 is obtained. In terms of quantity, compared with 2020, the area of agricultural land will expand in 2035, with a cumulative increase of 45,200 km². In terms of different regions, the agricultural land in North China will increase the most, with a total of 101,000 km², followed by the southwest and northeast regions, where the agricultural land will increase by 39,600 km² and 19,700 km² respectively; the agricultural land in other regions will decrease to varying degrees, and the decline in East China will be the largest, with a total of 26,900 km², the Northwest, Central China and South China will decrease by 17,300 km², 6,300 km² and 4,600 km² respectively. In terms of land types, the area of grassland and forest land will increase, while the area of dry land and paddy field will decrease. The area of grassland will increase the most, reaching 67,100 km², and the area of grassland will increase in all regions except East China, among which the area of South China will increase the most, reaching 37,400 km²; the area of forest land will increase by 40,400 km², and the area of Northeast China and East China will increase by 11,800 km² and 13,300 km² respectively, and the area of northwest will decrease by 18,400 kM²; the area of dry land will decrease the most, with a total decrease of 48,000 km², and the area of East China and Central China will decrease more, with a decrease of 26,300 km² and 17,700 km² respectively; the area of paddy fields will decrease slightly, a total of 14,200 km² will be reduced in 15 years (Table 8).

TABLE 8
Statistical table of agricultural land area in 2020 and 2035 (10,000 km²)

| | | Paddy | Dry | Forest | | |
|---|---|---|---|---|---|---|
| Scenario | Region name | field | land | land | Grassland | Total |
| Agricultural land in | North China | 0.30 | 26.78 | 25.45 | 60.23 | 112.76 |
| 2020 | Northeast China | 5.98 | 24.95 | 33.50 | 3.34 | 67.77 |
| | East China | 15.64 | 17.92 | 30.93 | 4.56 | 69.05 |
| | Central China | 9.15 | 13.75 | 25.00 | 2.26 | 50.17 |
| | South China | 5.21 | 5.35 | 27.57 | 2.90 | 41.04 |
| | Southwest | 8.13 | 19.64 | 67.59 | 84.79 | 180.15 |
| | China | | | | | |
| | Northwest | 1.18 | 23.45 | 14.57 | 111.63 | 150.82 |
| | China | | | | | |
| | Total | 45.59 | 131.84 | 224.61 | 269.71 | 671.76 |
| Agricultural land in | North China | 0.34 | 28.07 | 27.44 | 61.01 | 116.87 |
| 2035 | Northeast China | 6.38 | 23.98 | 34.68 | 4.69 | 69.74 |
| | East China | 14.57 | 15.29 | 32.25 | 4.25 | 66.35 |
| | Central China | 9.49 | 11.99 | 25.15 | 2.91 | 49.54 |
| | South China | 4.57 | 4.94 | 28.09 | 2.97 | 40.57 |
| | Southwest | 7.76 | 19.53 | 68.30 | 88.53 | 184.11 |
| | China | | | | | |
| | Northwest | 1.07 | 23.24 | 12.73 | 112.06 | 149.10 |
| | China | | | | | |
| | Total | 44.17 | 127.04 | 228.65 | 276.42 | 676.28 |

The distribution of agricultural land in 2035 has obvious differences between the east and the west. Most of the paddy fields and dry land are located in the east, most of the forest land is in the northeast and south, and the grassland is mainly in the northwest. From the perspective of spatial change, the regions where the area of paddy fields increased are mainly located in the Sanjiang Plain, the Liaohe Plain in Northeast China, and the Plain of Hunan and Hubei in Central China. The regions where the area of dry land increased are mainly located in the Loess Plateau and Haihe Plain in North China. The regions where the area of forest land increased are mainly located in the mountainous areas of the southwest, hills of the southeast, and mountainous areas of the Northeast and North China, the regions where the area of grassland increased are mainly distributed in traditional pastoral areas, such as the Inner Mongolia Autonomous Region, the Tibetan Plateau, and Xinjiang; the regions where the area of paddy fields decreased are mainly located in the Yangtze River Delta and Pearl River Delta, and the regions where the area of dry land decreased are mainly located in the Jiangnan hills and the Yangtze River Delta in the eastern coastal area, the regions where the area of forest land decreased are mainly located in the Tibetan Plateau in the southwest, and the regions where the area of grassland decreased was mainly located in Xinjiang in the northwest and Inner Mongolia in North China.

### 3.3 Pattern of Agricultural Carbon Emissions in 2035

Before estimating future agricultural carbon emissions, it is necessary to determine the amount of chemical fertilizer application, the number of different types of livestock, the number of rural populations, the output of major crops, the rate of straw return-to-field, and the proportion of early, middle and late rice planting in each province in 2035. Wherein, the amount of chemical fertilizer application, the number of livestock, crop output and rural population are estimated by using the linear regression method, and the provinces that have failed the test of significance are estimated by the annual rate of change between 1990 and 2020; the rate of straw return-to-field and the proportion of planting area of early, middle and late rice remain unchanged from the 2020 data.

The results are shown in Table 9, combined with Table 7, we can see that China's agricultural carbon emissions showed a fluctuating upward trend from 1990 to 2035. In 2035, the total agricultural carbon emissions will be 1.097 billion tons, an increase of 201 million tons compared with 2020, with an average annual increase of 13 million tons. In terms of regional distribution, agricultural carbon emissions will increase in all regions from 2020 to 2035. Among them, agricultural carbon emissions in South China are the largest, reaching 265 million tons, accounting for 24.17%, an increase of 67 million tons in 15 years. The increase in carbon emissions in this region may be related to the increase in straw return-to-field of sugar crops; agricultural carbon emissions in North China are the lowest, i.e., 100 million tons, accounting for 9.17%, an increase of 31 million tons in 15 years, but the increase rate was as high as 45%. The reason for this phenomenon is that the increase in the number of large livestock in North China has increased the carbon emissions generated by animal enteric fermentation; With the development of urbanization and the adjustment of the agricultural industrial structure in East China, agricultural carbon emissions in this region are gradually stabilizing, with an increase of only 8 million tons between 2020 and 2035, an increase rate of only 5%. From the perspective of carbon source structure, carbon emissions from straw return-to-field have increased significantly, and carbon emissions from rice planting have continued to decline, gradually forming a pattern of three carbon sources dominated by animal enteric fermentation, rice planting, and straw return-to-field. In 2035, carbon emissions from animal enteric fermentation will exceed the carbon emissions from rice planting, ranking the first, reaching 270 million tons, accounting for 24.6%; carbon emissions from rice planting and straw return-to-field will be 228 million tons and 205 million tons, respectively, accounting for 20.76% and 18.73% respectively; in addition, the carbon emissions from rice planting will decrease, the carbon emissions from manure will be generally stable, and the emissions from other carbon sources will increase. From the perspective of greenhouse gas types, methane emissions in 2035 will be 567 million tons, accounting for 51.7%; nitrous oxide emissions will be 530 million tons, accounting for 48.3%. The emissions of agricultural methane and nitrous oxide from 1990 to 2035 show a dynamic uptrend.

In general, there are significant regional differences in China's agricultural carbon emissions from 1990 to 2035. East China, South China, Southwest China, and Central China are the main regions of agricultural carbon emissions. As the main producers of rice in China, the above regions are all within the valid range of East Asian monsoon, with a dominant agricultural type of crop framing. In addition, the regions have large populations and a large consumer demand for meat and dairy products. More than half of the country's beef cattle and more than 80% of live pigs are raised there. Therefore, methane emissions from rice planting and animal enteric fermentation in the above-mentioned regions and nitrous oxide emissions from straw return-to-field have an important impact on China's agricultural carbon emissions.

TABLE 9
Agricultural carbon emissions in 2035

| | | 100 | | | 100 | |
|---|---|---|---|---|---|---|
| | | million | Proportion | Agricultural | million | Proportion |
| Agricultural carbon emission | | tons | (%) | carbon emission | tons | (%) |
| Region | North China | 1.01 | 9.17 | Northeast China | 1.08 | 9.85 |
| | East China | 1.78 | 16.24 | Central China | 1.62 | 14.79 |
| | South China | 2.65 | 24.17 | Southwest China | 1.78 | 16.2 |
| | Northwest China | 1.05 | 9.58 | | | |
| Carbon | Rice planting | 2.28 | 20.76 | Fertilizer | 1.27 | 11.55 |
| sources | | | | application | | |
| | Manure | 0.35 | 3.21 | straw | 2.05 | 18.73 |
| | | | | return-to-field | | |
| | Nitrogen | 0.48 | 4.36 | Leaching runoff | 0.47 | 4.24 |
| | deposition | | | | | |
| | Animal enteric | 2.70 | 24.6 | Animal manure | 1.38 | 12.54 |
| | fermentation | | | management | | |
| Type | CH₄ | 5.67 | 51.7 | N₂O | 5.30 | 48.3 |

As can be seen from Tables 7-10, it is expected that the spatial distribution pattern of agricultural carbon emissions in China will not change significantly in 2035 compared with 2020. The spatial distribution pattern in Northwest China and East China will remain stable, and two high-emission regions will be formed in Southwest China and Northeast China. Rice planting, fertilizer application, animal enteric fermentation, and animal manure management are important components of agricultural carbon emissions in most provinces. Although the continuous advancement of urbanization has taken up agricultural land in East and Central China, and the area of paddy fields has also declined, rice planting is still the main carbon source for the provinces in these regions; the number of livestock stocks in North China, Northeast China, and Northwest China continues to grow, especially the increase in the number of beef cattle and dairy cattle has further increased the carbon emissions from animal enteric fermentation, which constitutes the main part of agricultural carbon emissions in the above-mentioned regions; the agricultural carbon source in South China is still straw return-to-field. Separately, agricultural carbon emissions in most provinces will increase in 2035, and the provinces that will increase more are Guangxi, Inner Mongolia, Heilongjiang, Henan, and Yunnan. Among them, the main source of the increase in agricultural carbon emissions in Guangxi and Yunnan is straw return-to-field. The analysis found that under the background of natural development, sugarcane production in the province increased by 67.1600, resulting in an increase in carbon emissions; the increase in agricultural carbon emissions in Inner Mongolia and Heilongjiang is mainly caused by the expansion of livestock stocks such as beef cattle, dairy cows, goats, and sheep; unlike Inner Mongolia and Heilongjiang, the increase in agricultural carbon emissions in Henan is due to the rapid growth of pig stocks, which further increase carbon emissions during the storage and processing of pig manure.

TABLE 10
Agricultural carbon emissions table of provinces in China in 2035

| | | | | | | | Animal | Animal | |
|---|---|---|---|---|---|---|---|---|---|
| | Rice | Chemical | | | | Leaching | enteric | manure | |
| Province | planting | fertilizer | Manure | Straw | Deposition | Runoff | fermentation | management | Total |
| Beijing | 0.00 | 0.01 | 0.05 | 0.00 | 0.05 | 0.02 | 0.26 | 0.16 | 0.56 |
| Tianjin | 0.34 | 0.19 | 0.12 | 0.04 | 0.15 | 0.09 | 1.02 | 0.74 | 2.69 |
| Hebei | 0.78 | 3.72 | 1.09 | 0.80 | 1.81 | 1.48 | 13.23 | 6.60 | 29.51 |
| Shanxi | 0.02 | 0.87 | 0.38 | 0.27 | 0.57 | 0.41 | 4.10 | 1.99 | 8.61 |
| Inner | 0.84 | 4.32 | 1.68 | 0.81 | 2.57 | 1.83 | 38.67 | 8.49 | 59.23 |
| Mongolia | | | | | | | | | |
| Liaoning | 3.77 | 3.24 | 1.29 | 0.98 | 0.98 | 0.73 | 8.41 | 2.95 | 22.34 |
| Jilin | 4.21 | 4.59 | 1.28 | 1.54 | 1.14 | 0.97 | 8.66 | 3.12 | 25.50 |
| Heilongjiang | 18.83 | 7.23 | 2.23 | 3.35 | 2.00 | 1.69 | 19.38 | 5.51 | 60.21 |
| Shanghai | 1.00 | 0.05 | 0.10 | 0.01 | 0.05 | 0.02 | 0.15 | 0.14 | 1.52 |
| Jiangsu | 20.26 | 8.06 | 0.76 | 1.37 | 1.24 | 1.40 | 1.89 | 3.11 | 38.10 |
| Zhejiang | 9.69 | 1.57 | 0.44 | 0.52 | 0.39 | 0.35 | 0.36 | 1.06 | 14.37 |
| Anhui | 21.86 | 6.38 | 0.89 | 1.64 | 1.15 | 1.23 | 2.59 | 3.08 | 38.82 |
| Fujian | 5.22 | 3.55 | 0.70 | 0.45 | 0.42 | 0.40 | 0.72 | 1.47 | 12.94 |
| Jiangxi | 17.06 | 2.10 | 1.13 | 1.16 | 0.85 | 0.60 | 9.56 | 4.91 | 37.38 |
| Shandong | 0.46 | 4.67 | 1.43 | 1.12 | 2.36 | 1.90 | 12.89 | 10.27 | 35.10 |
| Henan | 6.12 | 9.89 | 1.84 | 1.74 | 3.76 | 3.54 | 11.64 | 15.72 | 54.25 |
| Hubei | 23.35 | 7.01 | 1.43 | 1.35 | 1.46 | 1.35 | 3.95 | 6.40 | 46.30 |
| Hunan | 28.33 | 5.31 | 2.67 | 1.38 | 1.92 | 1.29 | 8.94 | 11.92 | 61.76 |
| Guangdong | 13.74 | 10.05 | 2.18 | 14.29 | 1.97 | 2.23 | 1.03 | 4.05 | 49.54 |
| Guangxi | 13.81 | 10.16 | 2.39 | 148.56 | 9.62 | 13.58 | 3.20 | 5.98 | 207.29 |
| Hainan | 1.64 | 2.19 | 0.51 | 1.00 | 0.33 | 0.31 | 1.07 | 1.28 | 8.33 |
| Chongqing | 4.26 | 2.56 | 1.33 | 0.50 | 0.94 | 0.60 | 4.18 | 4.97 | 19.35 |
| Sichuan | 15.48 | 5.91 | 2.21 | 1.47 | 1.75 | 1.32 | 13.38 | 7.28 | 48.80 |
| Guizhou | 4.93 | 3.30 | 1.16 | 1.55 | 1.05 | 0.85 | 8.08 | 4.19 | 25.10 |
| Yunnan | 5.55 | 8.88 | 2.40 | 18.51 | 3.79 | 4.21 | 15.48 | 8.25 | 67.07 |
| Tibet | 0.09 | 0.09 | 0.42 | 0.03 | 0.43 | 0.14 | 13.90 | 2.31 | 17.41 |
| Shaanxi | 3.50 | 3.77 | 0.37 | 0.25 | 1.07 | 1.18 | 5.66 | 1.82 | 17.62 |
| Gansu | 0.11 | 1.49 | 0.76 | 0.22 | 1.04 | 0.66 | 16.29 | 2.60 | 23.17 |
| Qinghai | 0.00 | 0.07 | 0.46 | 0.02 | 0.46 | 0.15 | 13.55 | 1.74 | 16.44 |
| Ningxia | 2.53 | 0.73 | 0.23 | 0.08 | 0.37 | 0.28 | 4.52 | 0.94 | 9.67 |
| Xinjiang | 0.06 | 4.77 | 1.29 | 0.44 | 2.17 | 1.74 | 23.17 | 4.53 | 38.18 |
| Total | 227.81 | 126.74 | 35.23 | 205.44 | 47.86 | 46.55 | 269.91 | 137.61 | 1097.14 |

To sum up, agricultural carbon emissions in the southern provinces of China are mainly greenhouse gas emissions from rice planting, while those in the north are mainly greenhouse gas emissions from animal husbandry. With the development of China's economy, rice production is gradually concentrated in advantageous areas. The fluctuation range of the carbon emission ratio from rice production in provinces in the middle and lower reaches of the Yangtze River and Heilongjiang in the northeast is relatively stable; The share of carbon emissions from animal enteric fermentation in provinces in the agricultural and animal husbandry ecotones has grown. Provinces with high carbon emissions are mostly traditional agricultural provinces, showing a trend of shifting to southwest-northeast provinces.

### 4. CONCLUSION

The present invention utilizes the product and service supply and demand modules in the CLUMondo model to effectively characterize the planning intention in land use/cover change, that is, the goals and methods of land use change in national land space planning. The present invention sets the total output of rice, the number of livestock, and the area of construction land as the demand for land use products and services, and simulates the pattern of agricultural land under the natural development scenario in China in 2035. Therefore, the CLUMondo model can simulate land use under planning scenarios around planning indicators such as cultivated land holdings, forest coverage, wetland area, and construction land in a specific period.

The present invention studies and calculates the carbon emissions in China's agricultural field from 1990 to 2035, and analyzes the structural composition and spatial characteristics of the past and future agricultural carbon emissions. The research results show that the trend of agricultural carbon emissions in China from 1990 to 2035 can be divided into three stages: the continuous rising stage, the declining stage and the rising stage, showing a dynamic upward trend; the distribution pattern of agricultural land in 2035 is similar to that in 2020, with decrease in paddy fields, dry land and increase in forest land, grassland. During the study period, East China, South China, Southwest China, and Central China were high-emission regions, and the provinces with high carbon emissions gradually concentrated in the southwest-northeast direction; rice planting, chemical fertilizer application, animal enteric fermentation, and animal manure management are the main source of agricultural carbon emissions. The proportion of methane emissions has gradually decreased, and nitrous oxide emissions have increased significantly. In general, the present invention calculates carbon emissions in various scenarios based on the predicted agricultural land area, which can help farmers optimize the functional layout of agricultural subjects, explore green ecological planting and breeding models, and release the potential of carbon emission reduction from agricultural land and livestock and poultry.

The present invention further provides a system for carbon emission prediction from agricultural land, comprising:
An agricultural land area prediction module for predicting the agricultural land area of a target area at a future time using the CLUMondo model;
A paddy field methane emission prediction module for determining the paddy field methane emissions at a future time according to the planting area of rice in the agricultural land area;
A nitrous oxide emission prediction module for determining the direct and indirect nitrous oxide emissions at a future time according to the nitrogen input to the agricultural land area;
An animal carbon emission prediction module, which is used to determine methane emissions from animal enteric fermentation, methane emissions from animal manure management, and nitrous oxide emissions from animal manure management based on the number of animals in the said agricultural land area.

Compared with the prior art, the beneficial effects of the system for predicting carbon emission from agricultural land provided by the present invention are the same as that of the method for predicting carbon emission from agricultural land described in the above technical solution, and will not be repeated here.

Each embodiment in this specification is described in a progressive manner, focusing on its differences from other embodiments, and the same and similar parts between embodiments can be referred to mutually. For the method disclosed in the embodiments, the description is relatively simple since it corresponds to the device disclosed in the embodiment, and reference can be made to the device description section when needed.

The present invention elaborates the principle and embodiments of the invention based on a specific case and the description of the above embodiments intends only to help understand the method and the core idea of the present invention; At the same time, for those ordinarily skilled in the art, the idea based on the present invention may change in specific implementation and application scope. In summary, this specification shall not be understood as a restriction to the present invention.

1. A method for predicting carbon emission from agricultural land, applied on a CLUMondo model, comprising:
predicting an agricultural land area of a target area at a future time based on historical data;
determining methane emissions from a paddy field at the future time based on an area of the paddy field in the agricultural land area;
determining direct and indirect nitrous oxide emissions at the future time based on nitrogen input to the agricultural land area; and
determining methane emissions from animal enteric fermentation, methane emissions from animal manure management, and nitrous oxide emissions from animal manure management based on a number of animals in the agricultural land area;
wherein the determining the direct nitrous oxide emissions at the future time based on the nitrogen input to the agricultural land area comprises:
using a formula to determine the direct nitrous oxide emissions:
$${N}_{2} {O}_{direct} = ( {N}_{fertilizer} + {N}_{manure} + {N}_{straw} ) * {EF}_{direct} \\ {N}_{manure} = \text{} [ \text{} ( total nitrogen emissions from livestock and poultry - nitrogen emissions from natural decomposition of llivestock excreta during grazing - nitrogen produced by livestock excreta used as fuel ) + total nitrogen emissions from rual population ] * ( 1 - leaching and runoff loss rate 15 \% - volatilization loss 20 \% ) \\ {N}_{straw} = ( \frac{Crop grain yield}{Economic coefficient} - Crop grain yield ) * Rate of straw return - to - field * Nitrogen content of straw + \frac{Crop grain yield}{Economic coefficient} * Root - shoot ratio * Nitrogen content of straw$$
wherein, N₂O_{direct} represents the direct nitrous oxide emissions, N_{fertilizer} represents the direct nitrogen emissions from fertilizers, and EF_{direct} represents a factor of direct nitrous oxide emissions from the agricultural land area;
wherein, the determining the indirect nitrous oxide emissions at the future time based on nitrogen input to the agricultural land area comprises:
using a formula to determine the indirect nitrous oxide emissions:
$${N}_{2} {O}_{indirect} = {N}_{2} {O}_{deposition} + {N}_{2} {O}_{leaching} \\ {N}_{2} {O}_{deposition} = ( {N}_{livestock and poultry} * 20 \% + {N}_{input} * 10 \% ) * 0.01 \\ {N}_{2} {O}_{leaching} = {N}_{input} * 20 \% * 0.0075$$
wherein, N_{livestock and poultry} represents the volatilization of NH₃ and NOₓ from livestock and poultry manure, and Nᵢₙₚᵤₜ represents the volatilization of NH₃ and NOₓ from nitrogen input to the agricultural land.

2. The method for predicting carbon emission from agricultural land according to claim 1, wherein determining methane emissions from the paddy field at the future time based on the area of the paddy field in the agricultural land area comprises:
using a formula to determine methane emissions from the paddy field at the future time:
$$\sum {E}_{{Future}_{-} {CH}_{4}} = \sum {AD}_{{Future}_{-} i} * {EF}_{{Future}_{-} i}$$
wherein, ΣE_{Future_CH}_{₄} represents methane carbon emissions from the paddy fields, AD_{Future_i} is a sowing area of various types of paddy fields, and EF_{Future_i} is a methane emission factor of early, middle and late rice and i represents types of rice.

3. The method for predicting carbon emission from agricultural land according to claim 1, wherein determining methane emissions from animal enteric fermentation based on the number of animals in the agricultural land area comprises:
using a formula to determine the methane emissions from animal enteric fermentation:
$${E}_{{Fut}_{-} Ani {i}_{-} {CH}_{4}} = {EF}_{{Fut}_{-} Ant {i\_CH}_{4}} * {AP}_{i} * 1 {0}^{- 7}$$
wherein, E_{Fut_Ani i_CH}_{₄} represents methane emissions of a i^{th} animal at the future time, EF_{Fut_Ani i_CH}_{₄} represents a factor of methane emissions from the i^{th} animal, and APᵢ is the number of the i^{th} animal.

4. The method for predicting carbon emission from agricultural land according to claim 1, wherein the determining methane emissions from animal manure management based on the number of animals in the agricultural land area comprises:
using a formula to determine methane emissions from animal manure management:
$${E}_{Animal 2 {i\_CH}_{4}} = {EF}_{Animal 2 {i}_{-} C {H}_{4}} * {AP}_{i} * {10}^{- 7}$$
wherein, E_{Animal2 i_CH}_{₄} represents the methane emissions from animal manure management for the i^{th} animal, EF_{Animal2 i_CH}_{₄} represents a factor of methane emissions from animal manure management for the i^{th} animal and APᵢ represents the number of the i^{th} animal.

5. The method for predicting carbon emission from agricultural land according to claim 1, wherein the determining nitrous oxide emissions from animal manure management based on the number of animals in the agricultural land area comprises:
using a formula:
$${E}_{Animal {i}_{-} {N}_{2} O} = {EF}_{Animal {i}_{-} {N}_{2} O} * {AP}_{i} * 1 {0}^{- 7}$$
wherein, E_{Animal i_N}_{₂}_{O} represents the nitrous oxide emissions from animal manure management for the i^{th} animal, EF_{Animal i_N}_{₂}_{O} represents a factor of nitrous oxide emissions from animal manure management for the i^{th} animal and APᵢ represents the number of the i^{th} animal.

6. (canceled)
